(19) United States
(12) Patent Application Publication
(10) Pub. No.: US 2025/0303477 A1
(43) Pub. Date: Oct. 2, 2025

(54) HOLE DRILLING GUIDE KIT

(71) Applicant: William Erickson, III, Morgan Hill, CA (US)

(72) Inventor: William Erickson, III, Morgan Hill, CA (US)

(21) Appl. No.: 18/621,327

(22) Filed: Mar. 29, 2024

(51) Int. Cl. B23B 49/02; B23B 47/28

(52) U.S. Cl. CPC B23B 49/02; B23B 47/287

(57) ABSTRACT

A hole drilling guide kit for drilling holes in a workpiece includes a template with a base that has a first planar member and a second planar member. The first planar member is coupled to and extends perpendicularly away from the second planar member. The first planar member defines a pair of drill guide holes which extend through the first planar member and are spaced from each other in a direction parallel to the second planar member.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to drilling templates and more particularly pertains to a new drilling template for drilling holes in a workpiece.

### (2) Description of Related Art Including Information Disclosed Under 37 CFR 1.97 and 1.98

It is often necessary to drill holes into a workpiece near and parallel to a ledge of the workpiece. It can be time-consuming to pinpoint exact locations for the locations where holes are to be drilled in such circumstances using measuring and marking tools. Also, depending on working conditions, it may be difficult to see such markings. A template is therefore needed to make locating such planned holes in a workpiece easier and faster.

### BRIEF SUMMARY OF THE INVENTION

An embodiment of the disclosure meets the needs presented above by generally comprising a template with a base that has a first planar member and a second planar member. The first planar member is coupled to and extends perpendicularly away from the second planar member. The first planar member defines a pair of drill guide holes which extend through the first planar member and are spaced from each other in a direction parallel to the second planar member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective kit view of a hole drilling guide kit according to an embodiment of the disclosure.

FIG. 2 is a side view of a template of an embodiment of the disclosure.

FIG. 3 is a bottom view of a template of an embodiment of the disclosure.

FIG. 4 is a perspective view of a template of an embodiment of the disclosure.

FIG. 5 is a first perspective view of a bit adapter of an embodiment of the disclosure.

FIG. 6 is a second perspective view of a bit adapter of an embodiment of the disclosure.

FIG. 7 is a perspective view of a drill bit of an embodiment of the disclosure.

FIG. 8 is an in-use view of an embodiment of the disclosure.

### DETAILED DESCRIPTION OF THE INVENTION

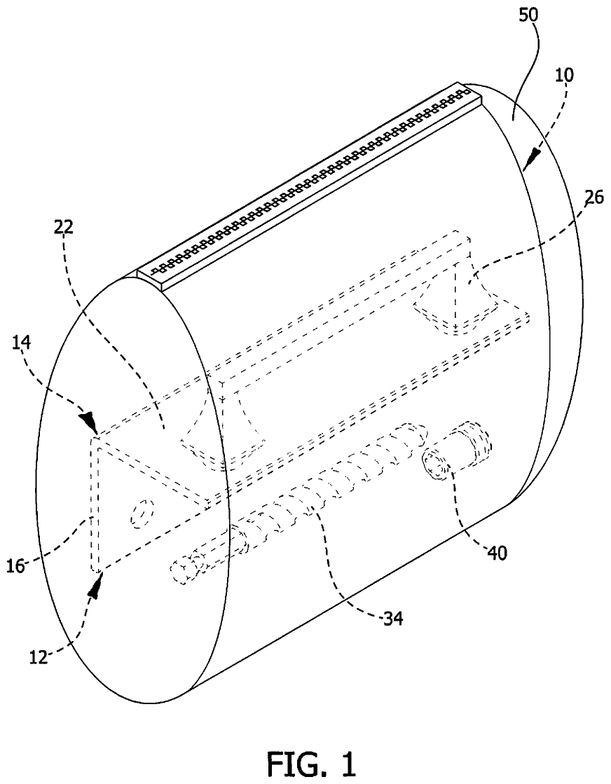

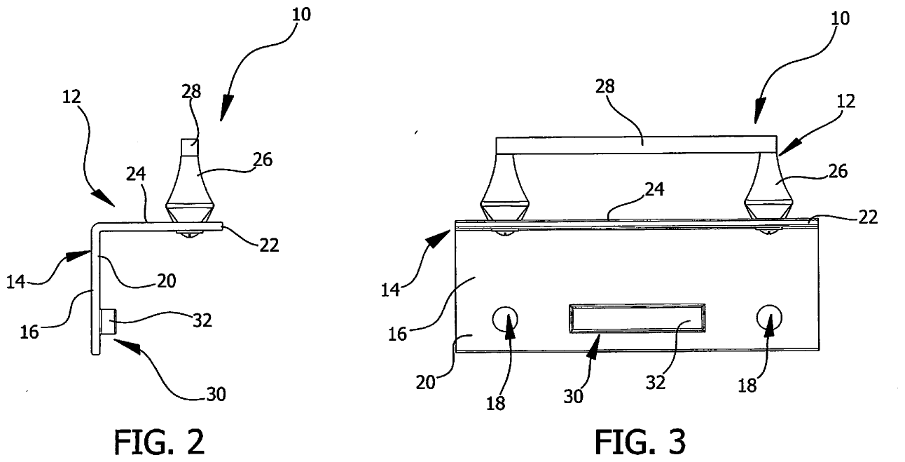

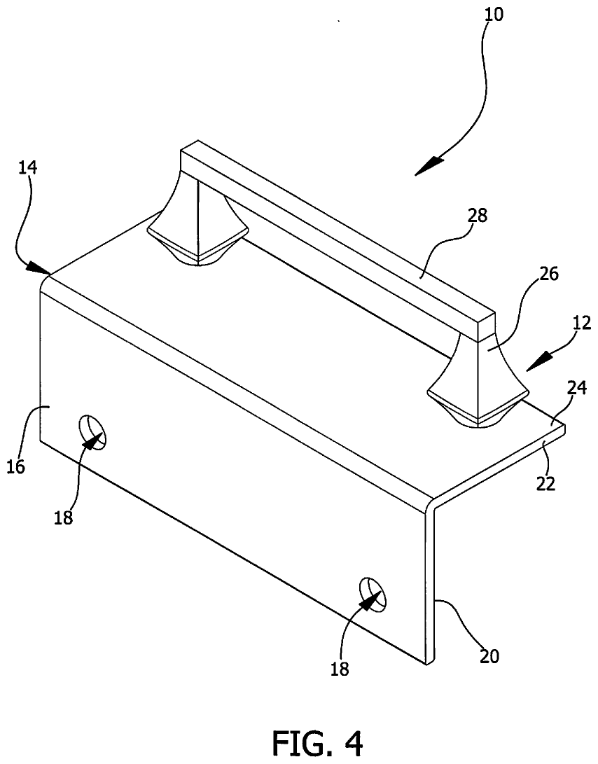

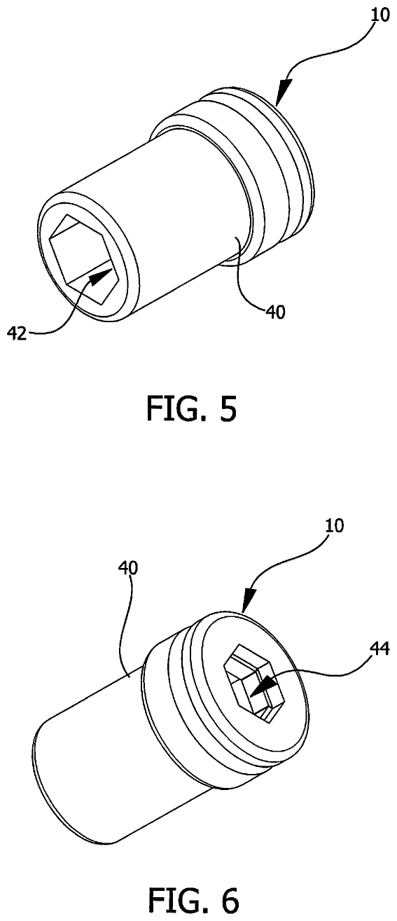

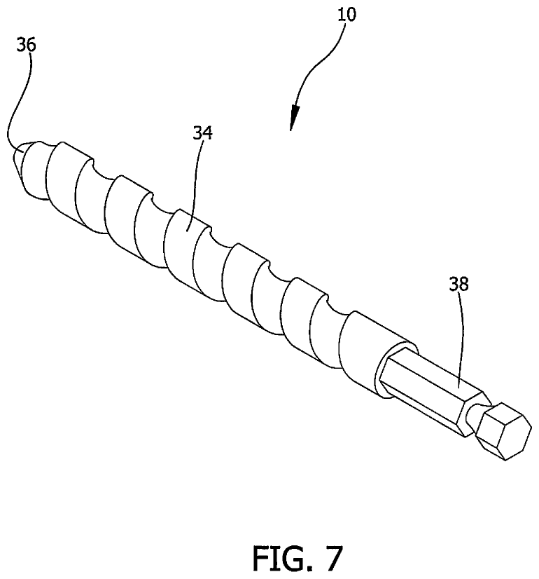

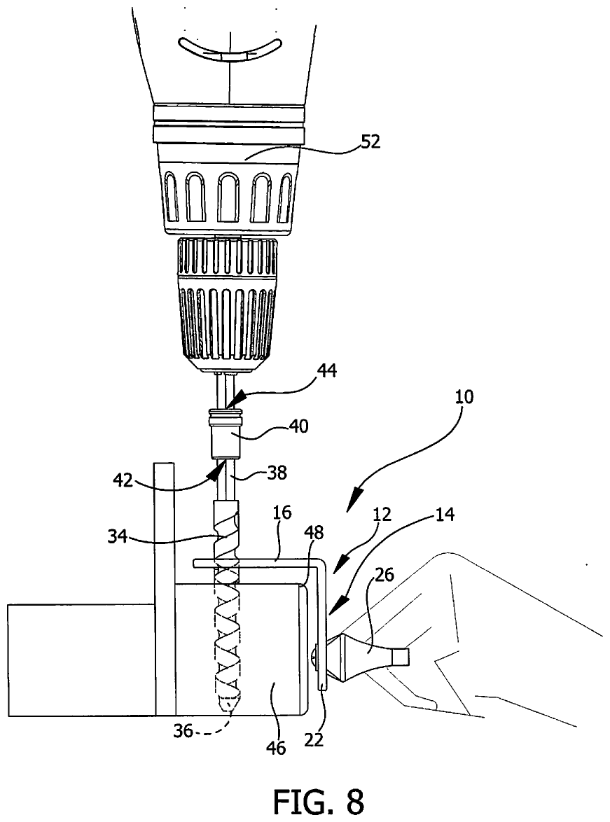

With reference now to the drawings, and in particular to FIGS. 1 through 8 thereof, a new drilling template embodying the principles and concepts of an embodiment of the disclosure and generally designated by the reference numeral 10 will be described.

As best illustrated in FIGS. 1 through 8, the hole drilling guide kit 10 generally comprises a template 12, a drill bit 34, and a bit adapter 40, all of which may be stored in a pouch 50 or other storage device. The template 12 comprises a base 14 which has a first planar member 16 and a second planar member 22. The first planar member 16 is coupled to and extends perpendicularly away from the second planar member 22, forming an L-shape with the second planar member 22. The first planar member 16 and the second planar member 22 may be defined by a piece of structural angle, for example. The first planar member 16 defines a pair of drill guide holes 18 which extend therethrough and are spaced from each other in a direction parallel to the second planar member 22.

The template 12 further comprises a handle 26 coupled to the base 14, which is positioned on an outer side 24 of the second planar member 22. The handle 26 has a grip portion 28 which extends perpendicularly to the first and second planar member 22s of the base 14. The handle 26 may have a color that makes the handle 26 more visible in a visually obscured environment. For example, the handle 26 may be made of brass or bronze, which contrasts with an environment of silver-or gray-colored metal or the like. The template 12 also has a connector 30 which is coupled to the base 14 and is configured to removably mount the base 14 to a workpiece 46. The connector 30 is positioned on an inner side 20 of the first planar member 16 of the base 14. The connector 30 comprises a magnet 32 so that the base 14 may magnetically attract a ferromagnetic material of the workpiece 46. In other embodiments, the connector 30 may be an adhesive, a clip, or other suitable fastener.

The drill bit 34 is complementary in size to each drill guide hole 18 of the pair of drill guide holes 18. The drill bit 34 has a drive portion 38 positioned opposite a drilling end 36 of the drill bit 34. The drive portion 38 has a hexagonal cross section but may have any suitable cross-sectional shape such as square, circular, or the like. The bit adapter 40 is configured to transfer a torque from a drill 52 to the drill bit 34. The bit adapter 40 defines a first socket 42 and a second socket 44 which are positioned opposite each other. The first socket 42 is hexagonal and complementary in size and shape to the drive portion 38 of the drill bit 34. The second socket 44 is hexagonal and has a different size from the drive portion 38 of the drill bit 34. The first socket 42 and the second socket 44 may have suitable alternative shapes such as square, star, triangular, or the like.

In use, the template 12 guides the drill bit 34 to form holes parallel to a ledge 48 of the workpiece 46 at a predetermined distance from each other. The template 12 is placed over the ledge 48 of the workpiece 46 such that the connector 30 mounts the template 12 to the workpiece 46 and the drill guide holes 18 lie parallel to the ledge 48. The drill 52 drives the drill bit 34, either directly or via the bit adapter 40, to form drilled holes in the workpiece 46 which align with the drill guide holes 18. The drilled holes thereby have a distance between each other equivalent to a distance between the drill guide holes 18. The template 12 is then removed from the workpiece 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hole drilling guide kit comprising:
a template comprising a base having a first planar member and a second planar member, the first planar member being coupled to and extending perpendicularly away from the second planar member, the first planar member defining a pair of drill guide holes which extend therethrough, the drill guide holes being spaced from each other in a direction parallel to the second planar member.

2. The kit of claim 1, wherein the template further comprises a handle coupled to the base, the handle being positioned on an outer side of the second planar member.

3. The kit of claim 2, wherein the handle has a grip portion which extends perpendicularly to the first and second planar members of the base.

4. The kit of claim 1, wherein the template further comprises a connector coupled to the base and configured to removably mount the base to a workpiece.

5. The kit of claim 4, wherein the connector is positioned on an inner side of the first planar member of the base.

6. The kit of claim 5, wherein the connector comprises a magnet.

7. The kit of claim 1, further comprising a drill bit complementary in size to each drill guide hole of the pair of drill guide holes, the drill bit having a drive portion positioned opposite a drilling end of the drill bit.

8. The kit of claim 7, wherein the drive portion has a hexagonal cross section.

9. The kit of claim 7, further comprising a bit adapter configured to transfer a torque from a drill to the drill bit, the bit adapter defining a first socket and a second socket, the first socket being positioned opposite the second socket, the first socket being complementary in size and shape to the drive portion of the drill bit, the second socket having a different size from the drive portion of the drill bit.

10. The kit of claim 9, wherein the second socket has a hexagonal shape.

11. A hole drilling guide kit comprising:
a template comprising:
a base having a first planar member and a second planar member, the first planar member being coupled to and extending perpendicularly away from the second planar member, the first planar member defining a pair of drill guide holes which extend therethrough, the drill guide holes being spaced from each other in a direction parallel to the second planar member;
a handle coupled to the base, the handle being positioned on an outer side of the second planar member, the handle having a grip portion which extends perpendicularly to the first and second planar members of the base; and
a connector coupled to the base and configured to removably mount the base to a workpiece, the connector being positioned on an inner side of the first planar member of the base, the connector comprising a magnet;
a drill bit complementary in size to each drill guide hole of the pair of drill guide holes, the drill bit having a drive portion positioned opposite a drilling end of the drill bit, the drive portion having a hexagonal cross section; and
a bit adapter configured to transfer a torque from a drill to the drill bit, the bit adapter defining a first socket and a second socket, the first socket being positioned opposite the second socket, the first socket being complementary in size and shape to the drive portion of the drill bit, the second socket having a different size from the drive portion of the drill bit, the second socket having a hexagonal shape.
